(19) United States
(12) Patent Application Publication
(10) Pub. No.: US 2005/0190976 A1
(43) Pub. Date: Sep. 1, 2005

(54) Moving image encoding apparatus and moving image processing apparatus

(75) Inventors: Akinari Todoroki, Hachioji-shi (JP); Taro Tanaka, Sapporo-shi (JP); Norihisa Hagiwara, Hachioji-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/044,459

(22) Filed: Jan. 28, 2005

(30) Foreign Application Priority Data
Feb. 27, 2004 (JP) 2004-054821
Feb. 27, 2004 (JP) 2004-054822

(51) Int. Cl. G06K 9/36; G06K 9/46; H04N 5/14

(52) U.S. Cl. 382/236; 382/238; 348/699

(57) ABSTRACT

To perform an adequate encoding process while cutting a data transfer amount in an encoding process of moving images.

A moving image processing apparatus 1 has a motion detection/motion compensation processing portions 80 as a coprocessor for performing a motion detection process as a process of a large calculation amount added to a processor 10 for managing an entire encoding or decoding process of a moving image, and has a buffer addressed to a plurality of memory banks by interleaving. A procedure for reading image data on the motion detection process is a predetermined method, and a section capable of adequately handling a case of reducing read image data is provided. As for the moving image processing apparatus according to the present invention, it is possible, with such a configuration, to perform an adequate encoding process while reducing a data transfer amount in the encoding process of the moving image.

### BACKGROUND OF THE INVENTION

1. Field of the Invention

The present invention relates to a moving image encoding apparatus for encoding a moving image and a moving image processing apparatus for encoding or decoding the moving image.

2. Description of the Related Art

In recent years, moving image encoding and decoding technologies are used in the cases of distributing moving images via a network, Terrestrial Digital Broadcast or accumulating the moving images as digital data.

In such cases of encoding the moving images, it is necessary to perform a lot of processing of which load is high, and in particular, it matters how to perform block matching in motion detection and data transfer from a frame memory in conjunction with it.

In this connection, various technologies have been proposed conventionally. For instance, JP6-113290A discloses a technology for performing a calculation of a sum of absolute difference between an image to be encoded and an image to be referred to not for all the pixels but for the images reduced to ½ and so on in order to cut a calculation amount in a motion detection process.

According to the technology described herein, the calculation amount for obtaining the sum of absolute difference decreases according to a reduction ratio of the images, and so it is possible to cut the amount and time of calculation.

In the cases of encoding and decoding the moving images as described above, it is possible to perform the processes with software. To speed up the processes, however, a part of the processes is performed by hardware. As for the encoding and decoding processes of the moving images, there is a lot of calculation of which load is high so that the encoding and decoding processes can be smoothly performed by having a part of the processes performed by the hardware.

The technology described in JP2001-236496A is known as the technology for having a part of the encoding process of the moving images performed by the hardware.

The technology described herein has a configuration in which an image processing peripheral for efficiently performing the calculation (the motion detection process in particular) is added to a processor core. It is possible, with this image processing peripheral circuit, to efficiently perform image processing of a large calculation amount so as to improve processing capacity.

As for the technology described in JP6-113290A, however, an image for obtaining a sum of absolute difference is reduced so that there is a possibility of degrading image quality in the case where a moving image is decoded.

As regards other conventionally known technologies, it is also difficult, in the encoding process of the moving images, to perform an adequate encoding process while cutting a data transfer amount (that is, to process it efficiently while preventing the image quality from degrading).

Furthermore, in the case of having a part of the process performed by hardware as described above, only the process easily performed by the hardware is executed by the hardware although collaboration between software and the hardware is necessary.

Including the cases of using a two-dimensional access memory, it is difficult to having a part of the process performed by the hardware while matching an interface of data of the software with that of the hardware.

The technology described in JP2001-236496A has a configuration suited to a motion detection process. However, it does not refer to generation of a predictive image and a difference image and a function of transferring those images to a local memory of a processor. In this respect, it cannot sufficiently improve encoding and decoding processing functions of the moving images.

Thus, there is no advanced collaboration between the software and hardware, and so it is difficult to encode and decode the moving image efficiently at low cost and with low power consumption.

A first object of the present invention is to perform the adequate encoding process while cutting the data transfer amount in the encoding process of the moving images. A second object of the present invention is to encode or decode the moving image efficiently at low cost and with low power consumption while implementing the advanced collaboration between the software and hardware.

### SUMMARY OF THE INVENTION

To attain the first object, the present invention is a moving image encoding apparatus for performing an encoding process including a motion detection process to moving image data, the apparatus including: an encoded image buffer (an encoding subject original image buffer 208 in FIG. 3 for instance) for storing one macroblock to be encoded of a frame constituting a moving image; a search image buffer (a search subject original image buffer 207 in FIG. 3 for instance) for storing the moving image data in a predetermined range as a search area of motion detection in a reference frame of the moving image data; and a reconstructed image buffer (a reconstructed image buffer 203 in FIG. 3 for instance) for storing the moving image data in a predetermined range as a search area of a reconstructed image frame (a reconstructed image stored in a frame memory 110 in FIG. 3 for instance) obtained by decoding the encoded reference frame, and comprises a motion detection processing section (a motion detection/motion compensation processing portions 80 in FIG. 1 for instance) for performing the motion detection process, and of the data constituting the frame constituting the moving image, the reference frame and the reconstructed image frame, the motion detection processing section sequentially reads predetermined data to be processed into each of the buffers so as to perform the motion detection process.

Thus, it is possible to provide the encoded image buffer, search image buffer and reconstructed image buffer as the buffers dedicated to the motion detection process and read and use necessary data as appropriate so as to perform the adequate encoding process while cutting the data transfer amount in the encoding process of the moving images.

It is the moving image encoding apparatus wherein at least one of the encoded image buffer, search image buffer and reconstructed image buffer has its storage area interleaved in a plurality of memory banks (SRAMs 301 to 303 in FIG. 5 for instance).

Thus, it is possible to calculate a predetermined number of pixels in parallel (calculation of the sum of absolute difference and so on) in the motion detection process so as to speed up the processing.

It is the moving image encoding apparatus wherein the storage area (that is, the storage area of the encoded image buffer, search image buffer and reconstructed image buffer) is divided into a plurality of areas having a predetermined width, and the predetermined width is set based on a readout data width (for instance, the data width of five pixels in the case where a sum of absolute difference processing portion 211 in FIG. 3 calculates the sum of absolute difference with half-pixel accuracy by using a reduced image as shown in FIG. 7) when the motion detection processing section reads the data and an access data width (the data width handled by the SRAMs 301 to 303 in FIG. 5 for instance) as a unit of handling in the memory banks, and each of the plurality of areas is interleaved in the plurality of memory banks.

To be more specific, it is possible to have a configuration in which a total of the access data widths of the plurality of memory banks simultaneously accessible is equal to or more than the readout data width of the motion detection processing section.

Thus, when the motion detection processing section reads the data from each buffer, it is possible to read all the pixels to be processed by accessing the memory banks once in parallel so as to speed up the processing.

It is the moving image encoding apparatus wherein the motion detection processing section calculates a sum of absolute difference in the motion detection process in parallel at the readout data width or less.

It is the moving image encoding apparatus wherein: the storage area is divided into two areas having a 4-byte width and each of the two areas is interleaved in the two memory banks (SRAMs 301 and 302 in FIG. 7 for instance); and the motion detection processing section processes a sum of absolute difference in the motion detection process by four pixels in parallel.

Thus, it is possible to have an adequate relation between a parallel processing data width and the readout data width in the calculation of the sum of absolute difference so as to perform the processing suited to the interleaved configuration.

It is the moving image encoding apparatus wherein the apparatus stores in the search image buffer a reduced image generated by reducing the moving image data in the predetermined range as the search area of the motion detection in the reference frame of the moving image data.

Thus, it is possible to reduce a storage capacity of the search image buffer and perform the motion detection process at high speed.

It is the moving image encoding apparatus wherein the apparatus stores in the search image buffer a first reduced image (one of the reduced macroblocks in FIG. 8 for instance) generated by reducing to a size of ½ the moving image data in the predetermined range as the search area of the motion detection in the reference frame of the moving image data and a second reduced image (the other reduced macroblock in FIG. 8 for instance) consisting of the rest of the moving image data reduced on generating the first reduced image.

Thus, it is possible to perform the motion detection process at high speed and perform an accurate motion detection process by using the first and second reduced images.

It is the moving image encoding apparatus wherein each of the storage areas of the search image buffer and reconstructed image buffer is interleaved in the same plurality of memory banks.

Thus, it is possible to reduce the number of memory banks provided to the motion detection processing section so as to allow reduction in manufacturing costs and improvement in a degree of integration on making an integrated circuit.

It is the moving image encoding apparatus wherein:
the search image buffer can store a predetermined number of macroblocks (nine macroblocks stored in the original image buffer 207 in FIG. 5 for instance) surrounding the macroblock located at a center of search; and the motion detection processing section detects a motion vector for the macroblocks stored in the search image buffer, reads the macroblock newly belonging to the search area due to a shift of the center of search, out of the predetermined number of macroblocks surrounding the macroblock located at the center of search, on shifting the center of search to an adjacent macroblock, and holds the other macroblocks (following a procedure as shown in FIGS. 12A to 12F for instance).

It is the moving image encoding apparatus wherein:
the search image buffer stores three lines and three rows of macroblocks surrounding the macroblock located at the center of search; and the motion detection processing section detects a motion vector for the three lines and three rows of macroblocks, reads the three lines or three rows of macroblocks newly belonging to the search area due to the shift of the center of search, out of the three lines and three rows of macroblocks surrounding the macroblock located at the center of search, on shifting the center of search to an adjacent macroblock, and holds the other macroblocks.

Thus, it is possible to send the data efficiently to the search image buffer.

It is the moving image encoding apparatus wherein, in the case where the range of the predetermined number of macroblocks surrounding the macroblock located at the center of search includes the outside of a boundary of the reference frame of the moving image data, the motion detection processing section interpolates the range outside the boundary of the reference frame by extending the macroblock located on the boundary of the reference frame.

Thus, it is possible to adequately perform the motion detection even in the case where the outside of the boundary of the reference frame is a search range of the motion detection.

It is the moving image encoding apparatus wherein, in the motion detection process, the motion detection processing section detects a wide-area vector indicating rough motion for the reduced image generated by reducing the moving image data in the predetermined range as the search area of the motion detection in the reference frame of the moving image data, and detects a more accurate motion vector thereafter based on the wide-area vector for a non-reduced image corresponding to the reduced image.

Thus, it is possible to perform a flexible and adequate encoding process by using an image reduced by reducing (reduced image) and the non-reduced image having accurate information (reconstructed image and so on).

Thus, according to the present invention, it is possible to perform the adequate encoding process while cutting the data transfer amount in the encoding process of the moving images.

To attain the second object, the present invention is a moving image processing apparatus including a processor for encoding moving image data and a coprocessor for assisting a process of the processor, wherein: the coprocessor (the motion detection/motion compensation processing portions 80 in FIG. 1 for instance) performs a motion detection process and a generation process of a predictive image and a difference image by the macroblock to the moving image data to be encoded, and outputs the difference image of the macroblock each time the process of the macroblock is finished; and the processor (a processor core 10 in FIG. 1 for instance) continuously encodes the difference image of the macroblock (DCT conversion to variable-length encoding and inverse DCT conversion, motion compensation process and so on for instance) each time the difference image of the macroblock is outputted from the coprocessor.

Thus, as the processor and coprocessor perform assigned processes by the macroblock respectively, it is possible to operate them in parallel more efficiently so as to encode the moving image efficiently at low cost and with low power consumption while implementing the advanced collaboration between the software and hardware.

It is the moving image processing apparatus including a frame memory (the frame memory 110 in FIG. 1 for instance) capable of storing a plurality of frames of the moving image data and a local memory (a local memory 40 in FIG. 1 for instance) accessible at high speed from the frame memory; the coprocessor reads the data on the frame stored in the frame memory and performs the motion detection process and generation process of the predictive image and difference image, and outputs a generated difference image to the local memory each time the difference image is generated for each macroblock; and the processor continuously encodes the difference image stored in the local memory.

Thus, as the processor and coprocessor can send and receive the data (macroblock of the difference image) via the frame memory or local memory, it is no longer necessary to synchronize the timing of sending and receiving of the data so that the encoding process can be performed more efficiently.

It is the moving image processing apparatus wherein: the coprocessor outputs a generated predictive image to the local memory each time the predictive image is generated for each macroblock; and the processor performs a motion compensation process based on the predictive image stored in the local memory and a decoded difference image obtained by encoding and then decoding the difference image, and stores are constructed image as a result of the motion compensation process in the local memory.

Thus, as the processor and coprocessor can send and receive the data (macroblock of the predictive image) via the frame memory or local memory, it is no longer necessary to synchronize the timing of the sending and receiving of the data so that the encoding process can be performed more efficiently.

It is the moving image processing apparatus wherein the coprocessor further includes a reconstructed image transfer section (a reconstructed image transfer portion 214 in FIG. 3 for instance) for DMA-transferring the reconstructed image stored in the local memory to the frame memory.

Thus, it is possible to transfer the reconstructed image from the local memory to the frame memory at high speed and reduce the load of the processor generated in conjunction with it.

It is the moving image processing apparatus wherein the coprocessor automatically generates an address referred to in the frame memory in response to the macroblocks sequentially processed on having a top address referred to in the frame memory and a frame size specified.

Thus, it is possible, in the case where the processor core performs the process by the macroblock, to calculate the address by ordering it once on storing the macroblock in the frame memory and reading it from the frame memory so as to calculate the address easily.

It is the moving image processing apparatus wherein the local memory is comprised of a two-dimensional access memory.

Thus, it is possible to assign the address flexibly on storing the macroblock in the local memory.

It is the moving image processing apparatus wherein, on storing the macroblock of the predictive image or difference image in the local memory, the coprocessor stores blocks included in the macroblock by placing them in a vertical line or in a horizontal line according to a size of the local memory.

Thus, it is possible to prevent the storage area from fragmentation even in the case where the size of the local memory is small so as to store the macroblock efficiently.

It is the moving image processing apparatus wherein the coprocessor includes the reconstructed image buffer (a reconstructed image buffer 203 in FIG. 3 for instance) for storing the data included in the reconstructed image as a result of undergoing the motion compensation process in the encoding process and reads predetermined data (only a Y component as a luminance component of the image as to a reference area of the reconstructed image for instance) included in the reconstructed image to the reconstructed image buffer on performing the motion detection process for the macroblock so as to generate the predictive image about the macroblock by using the predetermined data read to the reconstructed image buffer.

Thus, it is possible to reduce the number of times of reading the data from the frame memory so as to perform the process at high speed and with low power consumption.

It is the moving image processing apparatus wherein the coprocessor includes an encoding subject image buffer (the encoding subject original image buffer 208 in FIG. 3 for instance) for storing the data included in the moving image data to be encoded and reads predetermined data (Y component of the macroblock to be encoded for instance) included in the moving image data to be encoded to the encoding subject image buffer on performing the motion detection process for the macroblock so as to generate the difference image about the macroblock by using the data read to the encoding subject image buffer.

Thus, it is possible to reduce the number of times of reading the data from the frame memory so as to perform the process at high speed and with low power consumption.

It is the moving image processing apparatus wherein, as to the macroblock to be encoded, the coprocessor determines which of an inter-frame encoding process or an intra-frame encoding process can efficiently encode the macroblock based on the result of the motion detection process (the sum of absolute difference obtained in the motion detection for instance) and pixel data included in the macroblock and generates the predictive image and difference image based on the encoding process according to the result of the determination.

Thus, it is possible for the coprocessor to select a more efficient encoding method for each macroblock.

It is the moving image processing apparatus wherein, if determined that the intra-frame encoding process can encode the macroblock to be encoded more efficiently, the coprocessor updates the predictive image (storage area of the predictive image in the local memory 40) to be used for the encoding process of the macroblock to zero.

Thus, it is possible to select a more adequate encoding method and perform the process without adding a special configuration.

It is the moving image processing apparatus wherein the coprocessor detects a motion vector about each of the blocks included in the macroblock in the motion detection process and determines whether to set an individual motion vector to each block or set one motion vector (that is, setting contents in a 4 MV mode) to the entire macroblock according to a degree of approximation of detected motion vectors so as to generate the predictive image and difference image according to the result of the determination.

Thus, it is possible to set an efficient and adequate motion vector to each macroblock.

It is the moving image processing apparatus wherein, in the case where the detected motion vector specifies an area beyond a frame boundary of the frame referred to in the motion detection process, the coprocessor interpolates pixel data in the area beyond the frame boundary so as to generate the predictive image and difference image.

Thus, it is possible to use an unrestricted motion vector (motion vector admitting specification beyond the frame boundary) for the encoding process.

It is the moving image processing apparatus wherein, in the case where the motion vector about the macroblock is given, the coprocessor obtains the macroblock specified by the motion vector in the frame referred to, and the processor performs the motion compensation process by using the obtained macroblock so as to perform a decoding process of the moving image.

Thus, it is possible to exploit a decoding function provided to the moving image processing apparatus effectively and perform the process then by exploiting the above-mentioned effect.

It is the moving image processing apparatus wherein the processor stores in the frame memory the frame to be encoded, the reconstructed image of the frame referred to as a result of undergoing the motion compensation process in the encoding process, the frame referred to included in the moving image data to be encoded corresponding to the reconstructed image and the reconstructed image generated about the frame to be encoded so as to perform the encoding process by the macroblock, and overwrites the macroblock of the reconstructed image generated about the frame to be encoded in the storage area no longer necessary to be held from among the storage areas of the macroblock in the frame to be encoded, reconstructed image of the frame referred to, and the frame referred to.

Thus, it is possible to exploit the frame memory efficiently and reduce the capacity required of the frame memory.

The present invention is also a moving image processing apparatus including a processor for decoding moving image data and a coprocessor for assisting a process of the processor, wherein: in the case where the motion vector of the moving image data to be decoded is given, the coprocessor performs a process of obtaining the macroblock specified by the motion vector from the frame referred to obtained by a decoding process to generate a predictive image by the macroblock, and outputs the predictive image of the macroblock each time the process of the macroblock is finished; and the processor performs the motion compensation process to the predictive image of the macroblock each time the predictive image of the macroblock is outputted from the coprocessor.

Thus, according to the present invention, it is possible to encode or decode the moving image efficiently at low cost and with low power consumption while implementing the advanced collaboration between the software and hardware.

### BRIEF DESCRIPTION OF THE DRAWINGS

FIG. 1 is a block diagram showing a functional configuration of a moving image processing apparatus 1 according to the present invention;

FIG. 2 is a diagram showing a form in which macroblocks are stored in a local memory 40;

FIG. 3 is a block diagram showing an internal configuration of a motion detection/motion compensation processing portions 80;

FIG. 4 is a diagram showing a state in which a reducing processing portion 206 has reduced one macroblock read from a frame memory;

FIG. 5 is a diagram showing memory allocation of a reconstructed image buffer 203, a search subject original image buffer 207 and an encoding subject original image buffer 208;

FIG. 6 is a schematic diagram showing data contents stored in the reconstructed image buffer 203;

FIG. 7 is a diagram showing the memory allocation in the case of reducing image data and storing the image data reduced horizontally to ½ in the search subject original image buffer 207;

FIG. 8 is a diagram showing the memory allocation of the reconstructed image buffer 203 and encoding subject original image buffer 208 in the case where the image data is reduced;

FIG. 9 is a diagram showing the state in which the four motion vectors are set to the macroblock and the state in which one motion vector is set thereto;

FIG. 10 is an overview schematic diagram showing memory contents of a frame memory 110;

FIG. 11 is a flowchart showing an encoding function execution process executed by a processor core 10;

FIGS. 12A to 12F are diagrams showing state transition in the case where the image data to be searched is sequentially read to the search subject original image buffer 207;

FIG. 13 are schematic diagrams showing forms in which a search area is beyond a frame boundary;

FIG. 14 is a diagram showing an example of interpolation of peripheral pixels performed in the case where the search area is beyond the frame boundary in the form in FIG. 13A;

FIG. 15 is a diagram showing an example of the interpolation in the case of reducing the pixels; and

FIG. 16 is a diagram showing another example of the interpolation in the case of reducing the pixels.

### DETAILED DESCRIPTION OF THE PREFERRED EMBODIMENTS

Hereafter, embodiments of a moving image processing apparatus according to the present invention will be described by referring to the drawings.

The moving image processing apparatus according to the present invention has a coprocessor for performing a motion detection process as a process of a large calculation amount added to a processor for managing an entire encoding or decoding process of a moving image, and the coprocessor has a buffer addressed to a plurality of memory banks by interleaving. A procedure for reading image data on the motion detection process is a predetermined method, and a section capable of adequately handling the cases of reducing read image data is provided.

As for the moving image processing apparatus according to the present invention, it is possible, with such a configuration, to perform an adequate encoding process while reducing a data transfer amount in the encoding process of the moving image.

The moving image processing apparatus according to the present invention has the configuration in which the coprocessor for performing the motion detection or compensation process as the process of a large calculation amount is added to the processor for managing the entire encoding or decoding process of the moving image. As it has such a configuration, it performs the encoding or decoding process of the moving image not by a frame but by a macroblock. Furthermore, it uses a two-dimensional access memory (a memory for which two-dimensional data image is assumed, and the data is vertically and horizontally accessible) on performing the encoding or decoding process of the moving image.

Thus, as for the moving image processing apparatus according to the present invention, it is possible, with such a configuration, to encode or decode the moving image efficiently at low cost and with low power consumption while implementing advanced collaboration between software and hardware.

The encoding process of the moving image comprises the decoding process thereof. Therefore, a description will be given hereafter mainly about the encoding process of the moving image.

First, the configuration will be described.

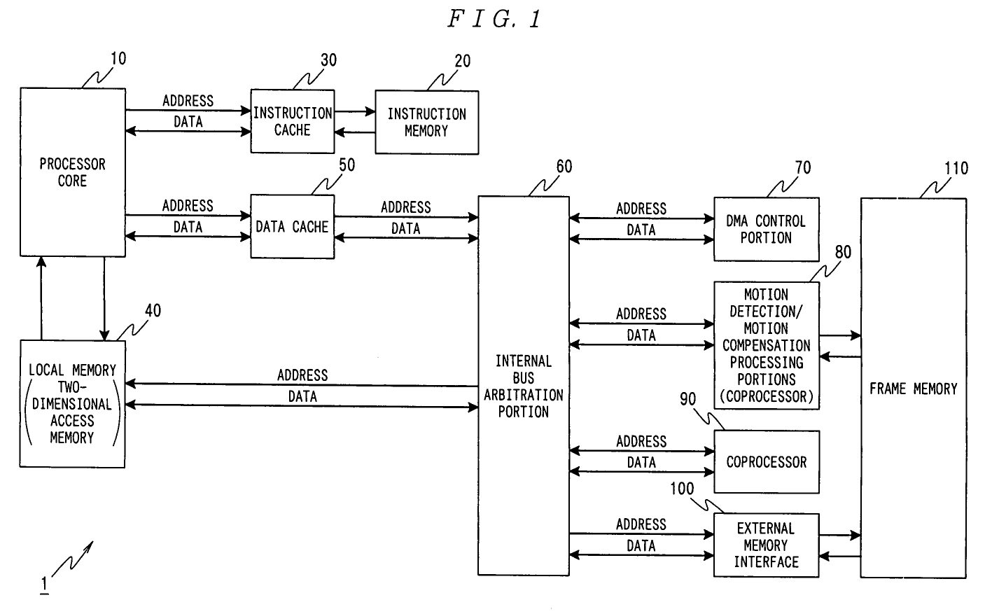

FIG. 1 is a block diagram showing a functional configuration of a moving image processing apparatus 1 according to the present invention.

In FIG. 1, the moving image processing apparatus 1 is comprised of a processor core 10, an instruction memory 20, an instruction cache 30, a local memory 40, a data cache 50, an internal bus adjustment portion 60, a DMA control portion 70, a motion detection/motion compensation processing portions 80, coprocessor 90, external memory interface (hereafter, referred to as an “external memory I/F”) 100 and a frame memory 110.

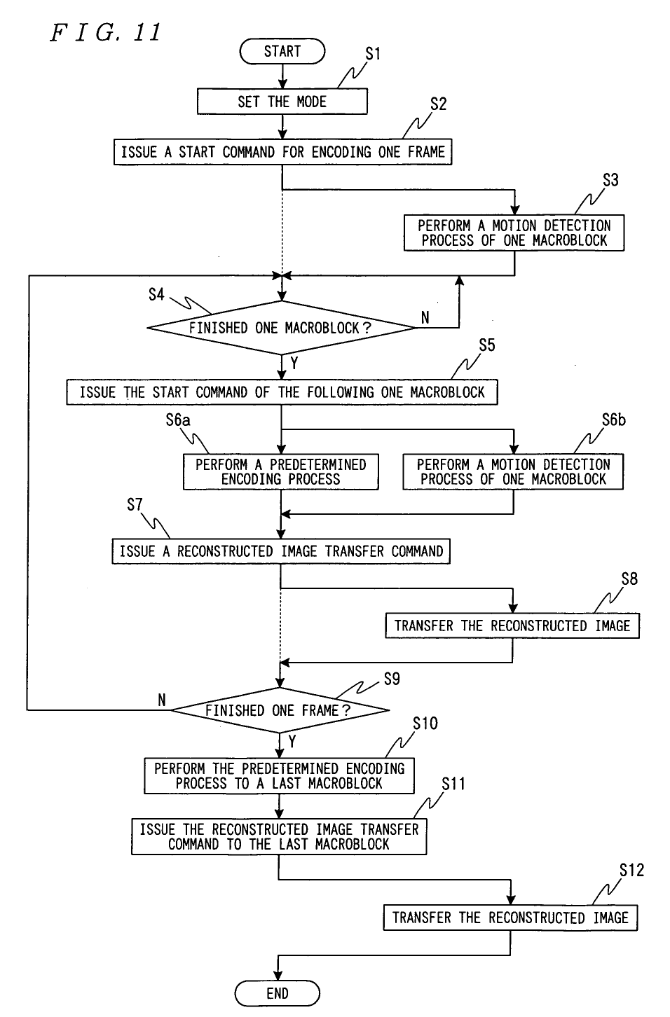

The processor core 10 controls the entire moving image processing apparatus 1, and manages the entire encoding process of the moving image while obtaining an instruction code stored at a predetermined address of the instruction memory via the instruction cache 30. To be more precise, it outputs an instruction signal (a start control signal, a mode setting signal and so on) to each of the motion detection/motion compensation processing portions 80 and the DMA control portion 70, and performs the encoding process following the motion detection such as DCT (Discrete Cosine Transform) or quantization. The processor core 10 executes an encoding function execution processing program (refer to FIG. 11) when managing the entire encoding process of the moving image.

Here, the start control signal is the instruction signal for starting each of the motion detection/motion compensation processing portions 80 in predetermined timing, and the mode setting signal is the instruction signal with which the processor core 10 provides various designations to the motion detection/motion compensation processing portions 80 for each frame, such as a search range in a motion vector detection process (which of eight pixels or sixteen pixels surrounding the macroblock located at the center of search should be the search range), a 4 MV mode (whether to perform the encoding with four motion vectors), the unrestricted motion vector (whether to allow a range beyond the frame boundary as a reference of the motion vector), rounding control, a frame compression type (P, B, I) and a compression mode (MPEG 1, 2 and 4).

The instruction memory 20 stores various instruction codes inputted to the processor core 10, and outputs the instruction code of a specified address to the instruction cache 30 according to reading from the processor core 10.

The instruction cache 30 temporarily stores the instruction code inputted from the instruction memory 20 and outputs it to the processor core 10 in predetermined timing.

The local memory 40 is the two-dimensional access memory for storing various data generated in the encoding process. For instance, it stores a predictive image and a difference image generated in the encoding process by the macroblock comprised of six blocks.

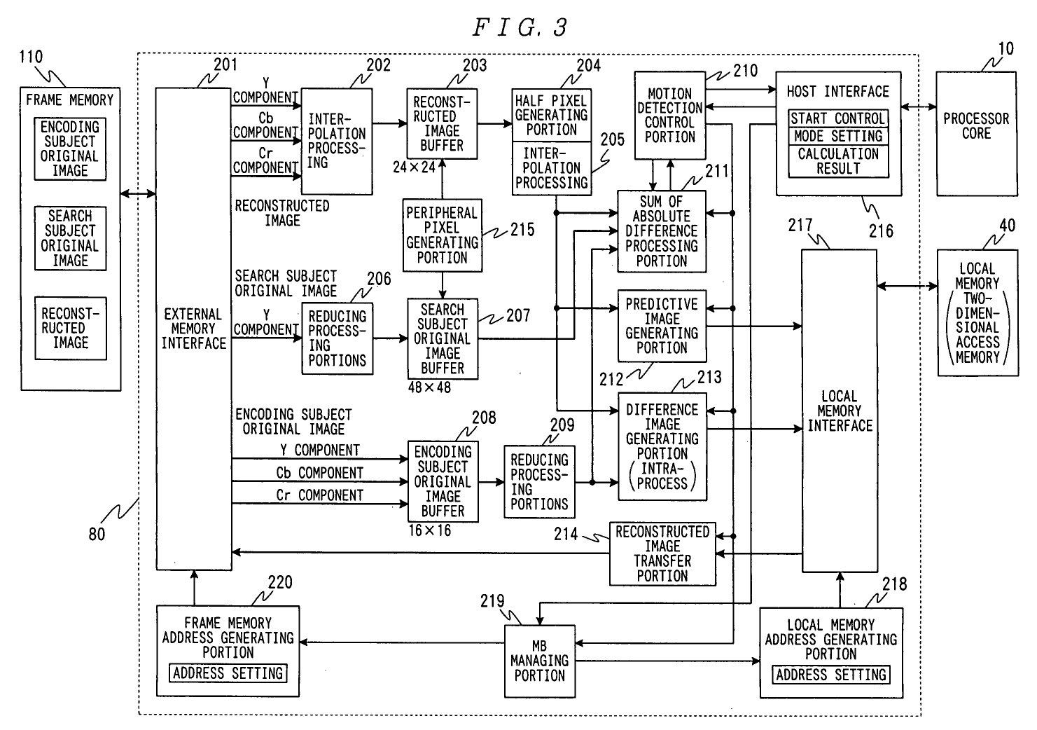

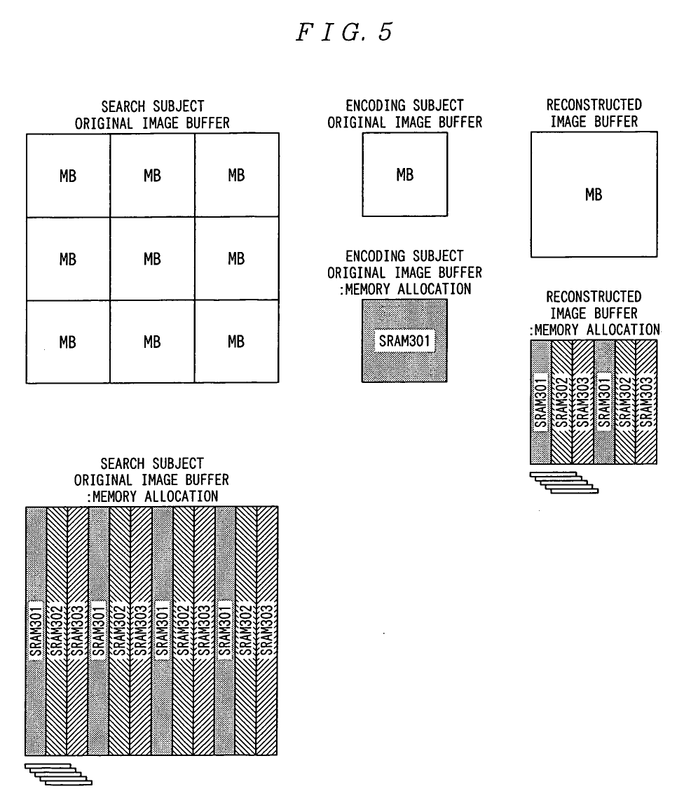

The two-dimensional access memory is the memory of the method described in JP2002-222117A. For instance, it assumes “a virtual minimum two-dimensional memory space 1 having total 16 pieces, that is, 4 pieces in each of vertical and horizontal directions, of virtual storage element 2 of a minimum unit capable of storing 1 byte (8 bits)” (refer to FIG. 1 of JP2002-222117A). And the virtual minimum two-dimensional memory space 1 is “mapped by being physically divided into four physical memories 4A to 4C in advance, that is, one virtual minimum two-dimensional memory space 1 is corresponding to a continuous area of 4 bytes beginning with the same address of the four physical memories 4A to 4C” (refer to FIG. 3 of JP2002-222117A). And an access shown in FIG. 5 of JP2002-222117A is possible in such a virtual minimum two-dimensional memory space 1.

Thus, it becomes easier to get access vertically and horizontally in the local memory 40 by rendering the local memory 40 as the two-dimensional access memory. Therefore, the macroblocks are stored in the local memory 40 in the following form according to the present invention.

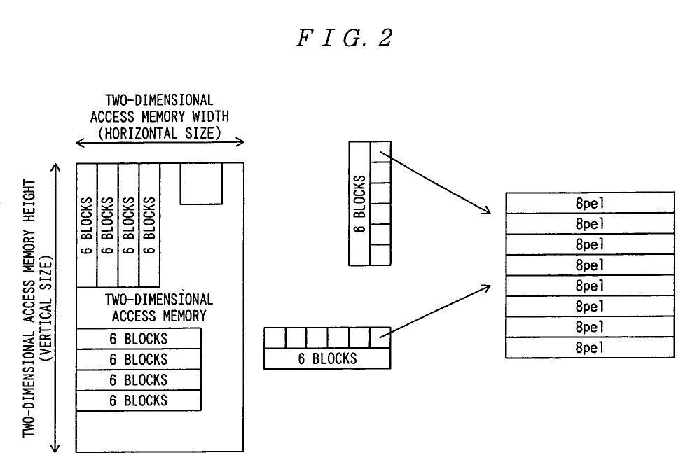

FIG. 2 is a diagram showing the form in which the macroblocks are stored in the local memory 40.

In FIG. 2, the six blocks constituting the macroblock (four blocks of the Y components and one block each of Cb and Cr components) are stored in the local memory 40 in a line vertically and horizontally. Furthermore, each of the blocks has eight pixels stored therein in a state of holding an 8×8 arrangement in the frame.

Thus, it is possible, by storing the six blocks constituting the macroblock in a line vertically and horizontally, to prevent the data from fragmentation so as to use the local memory 40 efficiently. Furthermore, it is also possible to use the local memory 40 efficiently according to the size of the local memory 40. For instance, in the case where a horizontal width of the local memory 40 is small, it is possible to store the macroblock efficiently in the local memory 40 by storing the six blocks vertically in a line. As for the description of FIG. 2, it describes the instance in which one macroblock is comprised of six blocks by assuming that the data of Y, Cb and Cr is held at 4:2:0. It can also be handled likewise by setting data configuration of Y, Cb and Cr at 4:2:2 or 4:4:4.

Returning to FIG. 1, the data cache 50 temporarily holds the data inputted and outputted between the processor core 10 and the internal bus adjustment portion 60, and outputs it in predetermined timing.

The internal bus adjustment portion 60 adjusts the bus inside the moving image processing apparatus 1. In the case where the data is outputted from the portions via the bus, it adjusts output timing between the portions.

The DMA (Direct Memory Access) control portion 70 exerts control on inputting and outputting the data between the portions without going through the processor core 10. For instance, in the case where the data is inputted and outputted between the motion detection/motion compensation processing portions 80 and the local memory 40, the DMA control portion 70 controls communication in place of the processor core 10 on finishing the input and output of the data, it notifies the processor core 10 thereof.

The motion detection/motion compensation processing portions 80 function as the coprocessor for performing the motion detection and motion compensation processes.

FIG. 3 is a block diagram showing an internal configuration of the motion detection/motion compensation processing portions 80.

In FIG. 3, the motion detection/motion compensation processing portions 80 are comprised of an external memory interface (I/F) 201, interpolation processing portions 202, 205, a reconstructed image buffer 203, a half pixel generating portion 204, reducing processing portions 206, 209, an search subject original image buffer 207, an encoding subject original, image buffer 208, a motion detection control portion 210, a sum of absolute difference processing portion 211, a predictive image generating portion 212, a difference image generating portion 213, a reconstructed image transfer portion 214, a peripheral pixel generating portion 215, a host interface (I/F) 216, a local memory interface (I/F) 217, a local memory address generating portion 218, a macroblock (MB) managing portion 219 and a frame memory address generating portion 220.

The external memory I/F 201 is an input-output interface for the motion detection/motion compensation processing portions 80 to send and receive the data to and from the frame memory 110 which is an external memory.

The interpolation processing portion 202 has the Y, Cb and Cr components of a predetermined macroblock in the reconstructed image (decoded frame) inputted thereto from the frame memory 110 via the external memory I/F 201. To be more precise, the interpolation processing portion 202 has the Y component of the reconstructed image inputted thereto in the case where the motion detection is performed. In this case, the interpolation processing portion 202 outputs the inputted Y component as-is to the reconstructed image buffer 203. In the case where the encoding process (generation of the predictive image and so on) following the motion detection is performed, the interpolation processing portion 202 has the Y, Cb and Cr components of the reconstructed image inputted thereto. In this case, the interpolation processing portion 202 interpolates the Cb and Cr components and outputs them to the reconstructed image buffer 203.

The reconstructed image buffer 203 interpolates the reconstructed image (macroblock) of 16×16 pixels inputted from the interpolation processing portion 202 with vertical and horizontal 8 pixels (surrounding 4 pixels) based on an instruction of the peripheral pixel generating portion 215 so as to store the data of 24×24 pixels (hereafter, referred to as a “reconstructed macroblock”). The reconstructed image buffer 203 will be described later (refer to FIG. 5).

The half pixel generating portion 204 generates the data on half-pixel accuracy from the reconstructed macroblock stored in the reconstructed image buffer 203. The half pixel generating portion 204 performs the process only when necessary, such as the cases where the reference of the motion vector is indicated with the half-pixel accuracy. Otherwise, it passes the data of the reconstructed macroblock as-is.

The interpolation processing portion 205 uses the data on the half-pixel accuracy generated by the half pixel generating portion 204 to interpolate the reconstructed macroblock and generate the reconstructed macroblock of the half-pixel accuracy. The interpolation processing portion 205 performs the process only when necessary as with the half pixel generating portion 204. Otherwise, it passes the data of the reconstructed macroblock as-is.

The reducing processing portion 206 reduces the Y components of a predetermined plurality of macroblocks (a search area at one time) in a search subject original image (reference frame) inputted via the external memory I/F 201 so as to generate a small image block of 48×48 pixels.

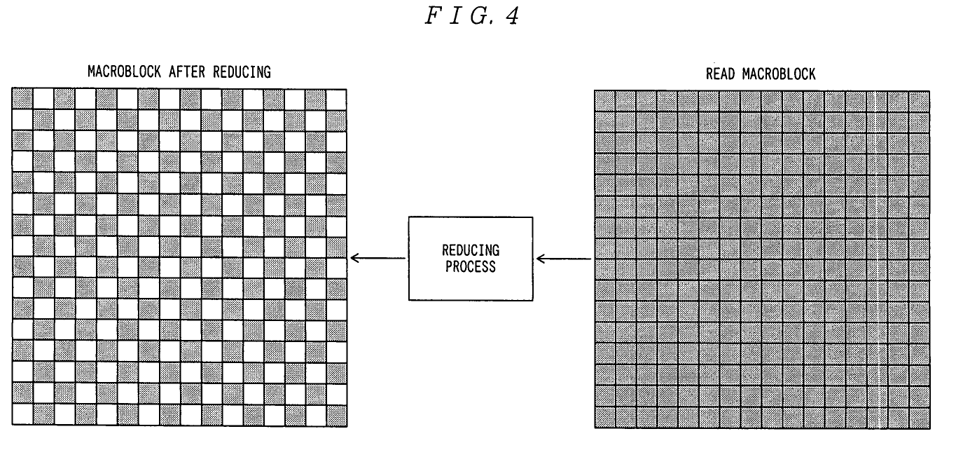

FIG. 4 is a diagram showing a state in which the reducing processing portion 206 has reduced one macroblock read from the frame memory.

In FIG. 4, the reducing processing portion 206 has reduced it by every other pixel included in the macroblock vertically and horizontally. To be more specific, the size of the macroblock is reduced to ½ by performing such a reducing process.

The reducing processing portion 206 reduces it by every other pixel vertically and horizontally and outputs both of the macroblocks separated into two (small image blocks) to the search subject original image buffer 207 as reduced macroblocks.

Thus, it is possible, by holding the two small image blocks generated by the reducing process, to perform in the motion detection process an adequate process by using two small image blocks in the case of detecting a pixel position with high accuracy or performing the process requiring a reduced and missing portion while performing the process efficiently by using one small image block. As the reducing process by the reducing processing portion 206 has the object such as reducing the size of the search subject original image buffer 207 described next or alleviating a processing load in the motion detection process, it does not have to be performed in the case where these conditions are allowed.

The search subject original image buffer 207 stores the small image block of 48×48 pixels generated by the reducing processing portion 206. In the case where the process by the reducing processing portion 206 is not performed, the Y components of the search subject original image are stored as-is in the search subject original image buffer 207.

The configuration of the search subject original image buffer 207 will be described later (refer to FIG. 5).

The encoding subject original image buffer 208 stores the Y, Cb and Cr components of the predetermined macroblock in the encoding subject original image (encoding subject frame) inputted from the frame memory 110 via the external memory I/F 201. To be more precise, the encoding subject original image buffer 208 has the Y component of the encoding subject original image inputted thereto in the case where the motion detection is performed. In the case where the encoding process (generation of the difference image and so on) following the motion detection is performed, the encoding subject original image buffer 208 has the Y, Cb and Cr components of the encoding subject original image inputted thereto.

Here, the configuration of the reconstructed image buffer 203, search subject original image buffer 207 and encoding subject original image buffer 208 will be concretely described.

FIG. 5 is a diagram showing memory allocation of the reconstructed image buffer 203, search subject original image buffer 207 and encoding subject original image buffer 208.

In FIG. 5, the search subject original image buffer 207 has total nine macroblocks of 3×3 including surroundings of the macroblock as the center of search stored therein. The search subject original image buffer 207 is comprised of three memory banks of SRAMs (Static Random Access Memories) 301 to 303, has a 32-bit wide (4-pixel wide) strip-like storage area allocated to each memory bank, and has the strip-like storage areas comprised of the memory banks arranged in order.

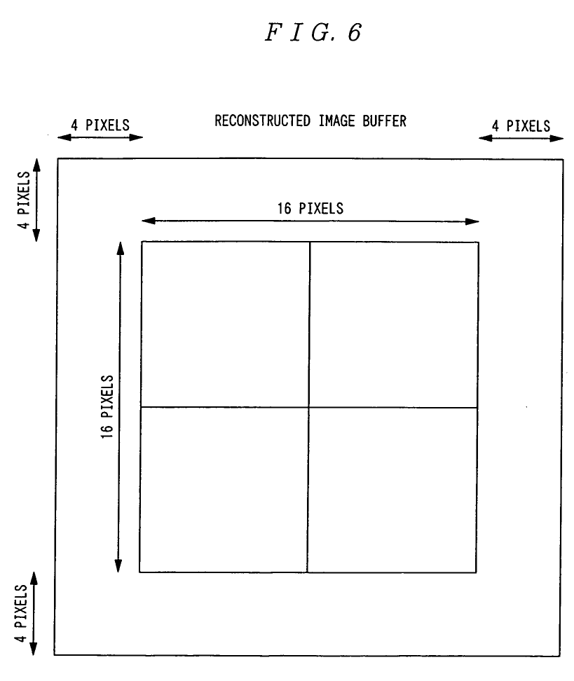

As shown in FIG. 6, the reconstructed image buffer 203 has 24×24 pixels, that is, 4 pixels surrounding one macroblock stored by expanding around it. Furthermore, the reconstructed image buffer 203 is comprised, as with the search subject original image buffer 207, of three memory banks of SRAMs 301 to 303, has a 32-bit wide (4-pixel wide) strip-like storage area allocated to each memory bank, and has the strip-like storage areas comprised of the memory banks arranged in order.

When the sum of absolute difference processing portion 211 detects the motion vector with the eight pixels as processing subjects in parallel, it is possible, by having such a configuration, to read all the eight pixels to be processed just by getting parallel access to the memory banks (SRAMs 301 to 303) once no matter which of the eight pixels is a lead pixel in reading.

Therefore, it is possible to render the process of having the motion vector detected by the sum of absolute difference processing portion 211 efficient and high-speed.

In FIG. 5, the encoding subject original image buffer 208 has one macroblock to be processed stored therein. Furthermore, the encoding subject original image buffer 208 is comprised of one of the SRAMs 301 to 303.

Thus, it is possible to reduce the number of the memories necessary for the motion detection/motion compensation processing portions 80 by constituting the reconstructed image buffer 203, search subject original image buffer 207 and encoding subject original image buffer 208 with the common memory bank. For that reason, it is possible to reduce the manufacturing costs of the moving image processing apparatus 1.

The search subject original image buffer 207 can store the image data by reducing it, in which case it is possible to further reduce a necessary memory amount.

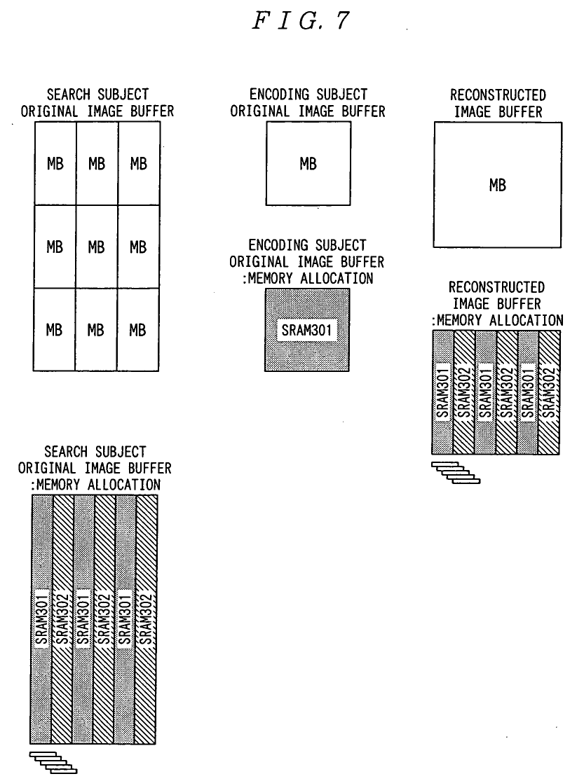

FIG. 7 is a diagram showing the memory allocation in the case of reducing the image data and storing the image data reduced horizontally to ½ in the search subject original image buffer 207.

In FIG. 7, the search subject original image buffer 207 has the total nine macroblocks of 3×3 including surroundings of the macroblock as the center of search stored therein by being reduced to ½ horizontally. The search subject original image buffer 207 is comprised of two memory banks of the SRAMs 301 and 302, has the 32-bit wide (4-pixel wide) strip-like storage area allocated to each memory bank, and further has the strip-like storage areas comprised of the memory banks arranged in order. To be more specific, the memory allocation is performed to the three memory banks in FIG. 5 while it is sufficient to perform the memory allocation to the two memory banks in FIG. 7. The encoding subject original image buffer 208 is comprised of the SRAM 303.

In the case of FIG. 7, it is also possible, as in the case of FIG. 5, to constitute the reconstructed image buffer 203 and encoding subject original image buffer 208 with the common memory bank.

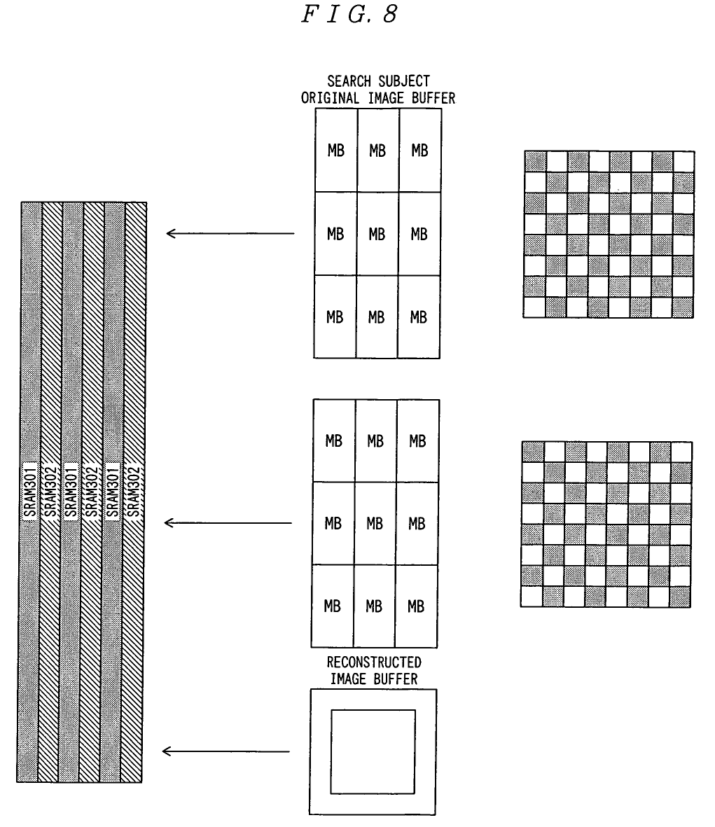

FIG. 8 is a diagram showing the memory allocation of the reconstructed image buffer 203 and encoding subject original image buffer 208 in the case where the image data is reduced.

FIG. 8 shows the state in which the reduced two macroblocks to be outputted by the reducing processing portion 206 are both stored.

Returning to FIG. 3, the reducing processing portions 209 reduces the macroblock of the encoding subject original image stored in the encoding subject original image buffer 208 when necessary. To be more precise, in the case where the motion detection is performed, the reducing processing portions 209 reduces the macroblock of the encoding subject original image and then outputs it to the sum of absolute difference processing portion 211. In the case where the encoding process (generation of the difference image and so on) following the motion detection is performed, the reducing processing portions 209 outputs the macroblock of the encoding subject original image as-is without reducing it to the difference image generating portion 213.

The motion detection control portion 210 manages the portions of the motion detection/motion compensation processing portions 80 as to the processing of each macroblock according to the instructions from the processor core 10. For instance, when processing one macroblock, the motion detection control portion 210 instructs the sum of absolute difference processing portion 211, predictive image generating portion 212 and difference image generating portion 213 to start or stop the processing therein, notifies the MB managing portion 219 of a finish of the process about one macroblock, and outputs the result of the processing by the sum of absolute difference processing portion 211 to the host interface 216.

Furthermore, based on the motion vector detected by the sum of absolute difference processing portion 211, the motion detection control portion 210 determines, as to each macroblock, whether the case of setting four motion vectors to each individual block and encoding it or the case of setting one motion vector to the entire macroblock and encoding it is suitable.

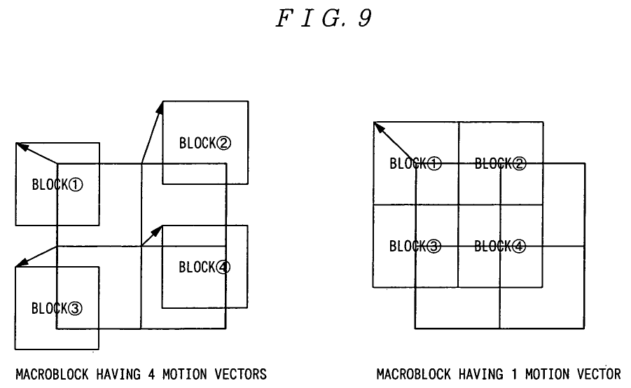

FIG. 9 is a diagram showing the state in which the four motion vectors are set to the macroblock and the state in which one motion vector is set thereto.

In the case where the motion vectors of the blocks are approximate, the motion detection control portion 210 determines that one macroblock is suitable. In the case where the motion vectors of the blocks are not approximate, it determines that the four motion vectors for each block are suitable.

The sum of absolute difference processing portion 211 detects the motion vectors according to the instructions from the motion detection control portion 210. To be more precise, the sum of absolute difference processing portion 211 calculates a sum of absolute difference of the images (Y components) included in the small image blocks stored in the search subject original image buffer 207 and the macroblock to be encoded inputted from the reducing processing portions 209 so as to obtain an approximate motion vector (hereafter, referred to as a “wide-area motion vector”). Then, of the reconstructed macroblocks stored in the reconstructed image buffer 203 correspondingly to obtaining the wide-area motion vector, the sum of absolute difference processing portion 211 searches for the macroblock of which sum of absolute difference is smaller, and thereby detects a further accurate motion vector to render it as a formal motion vector.

On performing such a process, the sum of absolute difference processing portion 211 calculates the sum of absolute differences of the Y components of the respective four blocks constituting the macroblock, the sum of absolute differences of the respective Cb and Cr components of each block, and the motion vectors about the respective four blocks constituting the macroblock so as to output the data as output results to the motion detection control portion 210.

According to the instruction from the motion detection control portion 210, the predictive image generating portion 212 generates the predictive image (the image constituted by using the reference of the motion vector) based on the reconstructed macroblock inputted from the interpolation processing portion 205 and the motion vector inputted from the motion detection control portion 210, and stores it in a predetermined area (hereafter, referred to as a “predictive image memory area”) in the local memory 40 via the local memory interface 217. The predictive image generating portion 212 performs the above-mentioned process in the case where the macroblock to be encoded is inter-frame-encoded. In the case where the macroblock to be encoded is intra-frame-encoded, it zero-clears (resets) the predictive image memory area.

According to the instruction from the motion detection control portion 210, the difference image generating portion 213 generates the difference image by taking a difference between the predictive image read from the predictive image memory area in the local memory 40 and the macroblock to be encoded inputted from the reducing processing portions 209, and stores it in a predetermined area (hereafter, referred to as a “difference image memory area”) in the local memory 40. In the case where the macroblock to be encoded is intra-frame-encoded, the predictive image is zero-cleared so that the difference image generating portion 213 renders the macroblock to be encoded as-is as the difference image.

According to the instruction from the motion detection control portion 210, the reconstructed image transfer portion 214 reads the reconstructed image as the result of the decoding process by the processor core 10 from the local memory 40, and outputs it to the frame memory 110 via the external memory I/F 201. To be more specific, the reconstructed image transfer portion 214 functions as a kind of DMAC (Direct Memory Access Controller).

The peripheral pixel generating portion 215 instructs the reconstructed image buffer 203 and the search subject original image buffer 207 to interpolate the surroundings of the inputted images with boundary pixels equivalent to a predetermined number of pixels respectively.

The host I/F 216 has a function of the input-output interface between the processor core 10 and the motion detection/motion compensation processing portions 80. The host I/F 216 outputs the start control signal and mode setting signal inputted from the processor core 10 to the motion detection control portion 210 and MB managing portion 219 or temporarily stores calculation results (motion vector and so on) inputted from the motion detection control portion 210 so as to output them to the processor core 10 according to a read request from the processor core 10.

The local memory I/F 217 is the input-output interface for the motion detection/motion compensation processing portions 80 to send and receive the data to and from the local memory 40.

The local memory address generating portion 218 sets various addresses in the local memory 40. To be more precise, the local memory address generating portion 218 sets top addresses of a difference image block (storage area of the difference images generated by the difference image generating portion 213), a predictive image block (storage area of the predictive images generated by the predictive image generating portion 212) and the storage area of decoded reconstructed images (reconstructed images decoded by the processor core 10) in the local memory 40. The local memory address generating portion 218 also sets the width and height of the local memory 40 (two-dimensional access memory). If instructed to access the local memory 40 by the MB managing portion 219, the local memory address generating portion 218 generates the address in the local memory 40 for storing and reading the macroblocks and so on according to the instruction so as to output it to the local memory I/F 217.

The MB managing portion 219 exerts higher-order control than the control exerted by the motion detection control portion 210, and exerts various kinds of control by the macroblock. To be more precise, the MB managing portion 219 instructs the local memory address generating portion 218 to generate the address for accessing the local memory 40 and instructs the frame memory address generating portion 220 to generate the address for accessing the frame memory 110 based on the instructions from the processor core 10 inputted via the host I/F 216 and the results of the motion detection process inputted from the motion detection control portion 210.

The frame memory address generating portion 220 sets various addresses in the frame memory 110. To be more precise, the frame memory address generating portion 220 sets the top address of the storage area of Y components relating to the search subject original image, top address of the storage area of each of the Y, Cb and Cr components relating to the reconstructed images for reference, top address of the storage area of each of the Y, Cb and Cr components relating to the encoding subject original image, and top address of the storage area of each of the Y, Cb and Cr components relating to the reconstructed image for output (reconstructed image outputted to the motion detection/motion compensation processing portions 80). The frame memory address generating portion 220 sets the width and height of the frame stored in the frame memory 110. If instructed to access the frame memory 110 by the MB managing portion 219, the frame memory address generating portion 220 generates the address in the frame memory 110 for storing and reading the data stored in the frame memory 110 according to the instruction so as to output it to the external memory I/F 201.

Returning to FIG. 1, the coprocessor 90 is the coprocessor for performing the process other than the motion detection and motion compensation process, and performs a floating-point operation for instance.

The external memory I/F 100 is the input-output interface for the moving image processing apparatus 1 to send and receive the data to and from the frame memory 110 which is an external memory.

The frame memory 110 is the memory for storing the image data and so on generated when the moving image processing apparatus 1 performs various processes. The frame memory 110 has the storage area of the Y components relating to the search subject original image, storage area of each of the Y, Cb and Cr components relating to the reconstructed image for reference, storage area of each of the Y, Cb and Cr components relating to the encoding subject original image, and storage area of each of the Y, Cb and Cr components relating to the reconstructed image for output. The addresses, widths and heights of these storage areas are set by the frame memory address generating portion 220.

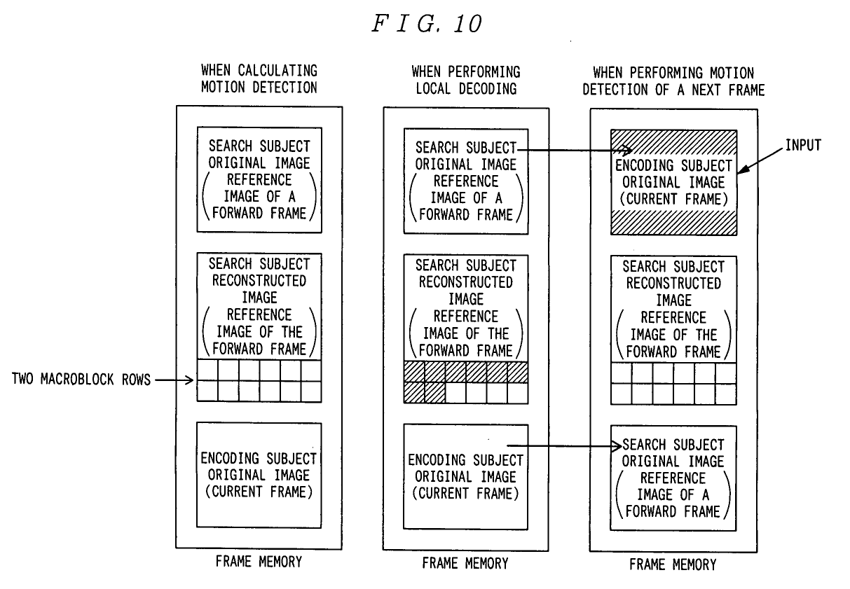

FIG. 10 is an overview schematic diagram showing memory contents of the frame memory 110. FIG. 10(a) shows the state on the motion detection process of a current frame. FIG. 10 (b) shows the state on a local decoding process (on generating the reconstructed image). And FIG. 10(c) shows the state on the motion detection process of a next frame.

In FIG. 10(a) to (c), the search subject original image and the encoding subject original image are the storage areas of the same size, and the storage area of the reconstructed image to be searched for is secured by further adding two rows (16 pixels) of the macroblock. This is based on an encoding processing method of the moving image processing apparatus 1. To be more specific, it is the method whereby the moving image processing apparatus 1 performs the encoding process by the macroblock, and so the frame (reconstructed image) cannot be immediately updated even after the macroblock finishes the encoding process. As the search range is 16 pixels at the maximum surrounding the macroblock as the center of search, two rows of the macroblocks are secured in addition to one frame. In the case of handling over 16 pixels, that is, up to 24 pixels as the search range for instance, it is necessary to secure three rows of the macroblocks secured in addition to one frame.

Thus, it is possible to perform the encoding process according to the present invention by the macroblock while curbing increase in necessary storage capacity of the frame memory 110.

In the case of individually securing the storage area of the reconstructed image to be referred to and the storage area of the reconstructed image to be referred to next, an inconvenience described above will not arise even though the storage capacity increases a little. Therefore, each storage area should be equivalent to one frame.

Next, the operation will be described.

First, the operation relating to the entire moving image processing apparatus 1 will be described.

FIG. 11 is a flowchart showing the encoding function execution process (process based on the encoding function execution processing program) executed by the processor core 10. The process in FIG. 11 is the process constantly executed when encoding the moving image on the moving image processing apparatus 1, which is the process for encoding one frame. In the case where the moving image processing apparatus 1 encodes the moving image, the encoding function execution process shown in FIG. 11 is repeated as appropriate. In FIG. 11, steps S3, 6a, 8 and 12 are the processes executed by the coprocessor 90, and the others are the processes executed by the processor core 10.

In FIG. 11, if the encoding function execution process is started, a mode setting relating to the frame is performed (step S1), and a start command for encoding one frame (including the start command of the first macroblock) will be issued to the motion detection/motion compensation processing portions 80 (step S2).

Then, the motion detection/motion compensation processing portions 80 is initialized (has various parameters set), and the motion detection process of one macroblock, generation processes of the predictive image and difference image are performed (step S3). And the processor core 10 determines whether or not the motion detection process of one macroblock is finished (step S4).

If determined that the motion detection process of one macroblock is not finished in the step S4, the processor core 10 repeats the process of the step S4. If determined that the motion detection process of one macroblock is finished, it issues the start command for the motion detection process of the following one macroblock (step S5).

Subsequently, the motion detection/motion compensation processing portions 80 performs the motion detection process of a following one macroblock, generation process of the predictive image and difference image (step S6a). In parallel with it, the processor core 10 performs the encoding process from DCT conversion to variable-length encoding, inverse DCT conversion and motion compensation process (step S6b).

Next, the processor core 10 issues to the motion detection/motion compensation processing portions 80 the command to transfer the reconstructed image generated in the step S6b from the local memory 40 to the frame memory 110 (hereafter, referred to as an “reconstructed image transfer command”) (step S7).

Then, the reconstructed image transfer portion 214 of the motion detection/motion compensation processing portions 80 transfers the reconstructed image generated in the step S6b from the local memory 40 to the frame memory 110 (step S8), and the processor core 10 determines whether or not the encoding process of one frame is finished (step S9).

If determined that the encoding process of one frame is not finished in the step S9, the processor core 10 moves on to the process of the step S4. If determined that the encoding process of one frame is finished, the processor core 10 performs the encoding process from the DCT conversion to the variable-length encoding, inverse DCT conversion and motion compensation process to the macroblock lastly processed by the motion detection/motion compensation processing portions 80 (step S10).

And the processor core 10 issues to the motion detection/motion compensation processing portions 80 the reconstructed image transfer command about the reconstructed image generated in the step S10 (step S11).

Then, the reconstructed image transfer portion 214 of the motion detection/motion compensation processing portions 80 transfers the reconstructed image generated in the step S10 from the local memory 40 to the frame memory 110 (step S12), and the processor core 10 finishes the encoding function execution process.

When the motion detection/motion compensation processing portions 80 perform the motion detection process, generation processes of the predictive image and difference image in the steps S3 and S6a, it is possible to read the macroblocks by accessing the SRAMs 301 to 303 in parallel at one time as described above.

Next, a description will be given as to state transition in the search subject original image buffer 207 of the motion detection/motion compensation processing portions 80.

In the case where the encoding process is performed by the moving image processing apparatus 1, the area of surrounding eight pixels (equivalent to one macroblock) centering on the macroblock as the center of search is sequentially read to the search subject original image buffer 207.

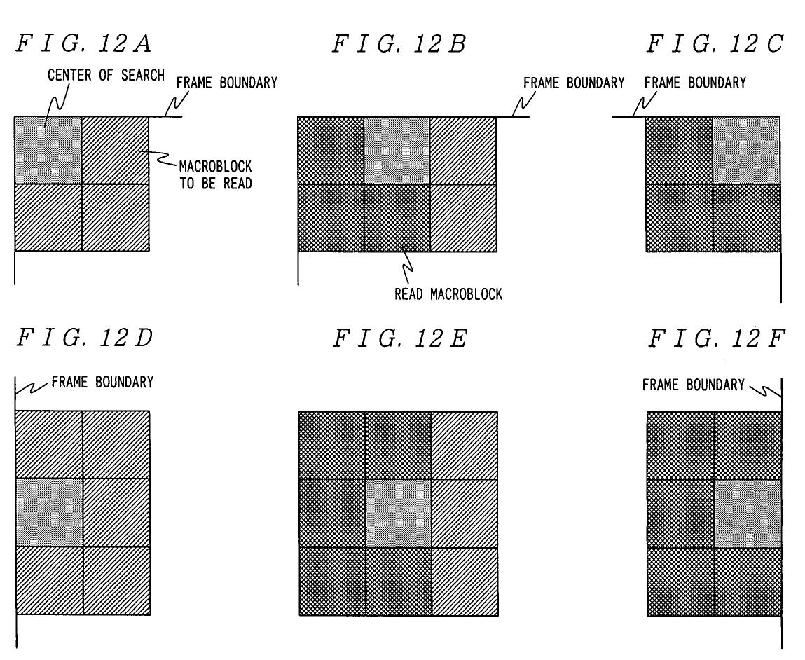

FIGS. 12A to 12F are diagrams showing the state transition in the case where the image data to be searched is sequentially read to the search subject original image buffer 207.

In FIGS. 12A to 12F, in the case where the macroblock at a start of one frame (upper left) is stored as the center of search, the search subject original image buffer 207 has the macroblocks surrounding the upper left macroblock, that is, those to its immediate right, lower right and beneath it read thereto (refer to FIG. 12A). The data on the area beyond the frame boundary is interpolated by the peripheral pixel generating portion 215 as will be described later.

If the center of search moves on to the next macroblock, the search subject original image buffer 207 has only the two macroblocks to the right of the macroblock read in FIG. 12A newly read thereto. As for the macroblocks overlapping the search area in FIG. 12A, those already read are used as-is (refer to FIG. 12B).

Thereafter, each time the center of search moves on to the next macroblock, only the two macroblocks to the right are newly read likewise until the center of search reaches the macroblock located at a right end on the highest line of the frame (refer to FIG. 12C). In this case, there is no macroblock to newly read on its right so that no macroblock is read and the surrounding pixels are interpolated instead.

Subsequently, the center of search moves on to the second line of the frame. In this case, there is no macroblock overlapping the search area in FIG. 12C in the search subject original image buffer 207 so that all the macroblocks are newly read thereto (refer to FIG. 12D).

And if the center of search moves on to the next macroblock, the search subject original image buffer 207 has only the three macroblocks to the right of the macroblock already read in FIG. 12D newly read thereto. As for the macroblocks overlapping the search area in FIG. 12D, those already read are used as-is (refer to FIG. 12E).

Thereafter, each time the center of search moves on to the next macroblock, only the three macroblocks to the right are newly read likewise until the center of search reaches the macroblock located at the right end on the second line of the frame (refer to FIG. 12F). In this case, there is no macroblock to newly read on its right so that no macroblock is read and the surrounding pixels are interpolated instead.

Thereafter, the same process is performed on each line of the frame, and the same process is also performed on the lowest line of the frame. In the case of the lowest line of the frame, as described above, the surrounding pixels are interpolated beneath the macroblock as the center of search being beyond the frame boundary.

As the macroblocks read to the search subject original image buffer 207 thus transit, it is possible to perform the process efficiently without redundantly reading the macroblocks already read.

Next, a description will be given as to the process of the peripheral pixel generating portion 215 interpolating the search range beyond the frame boundary.

As described above, in the case where the macroblock located at the frame boundary is the center of search, a part of the search area has no macroblock to read.

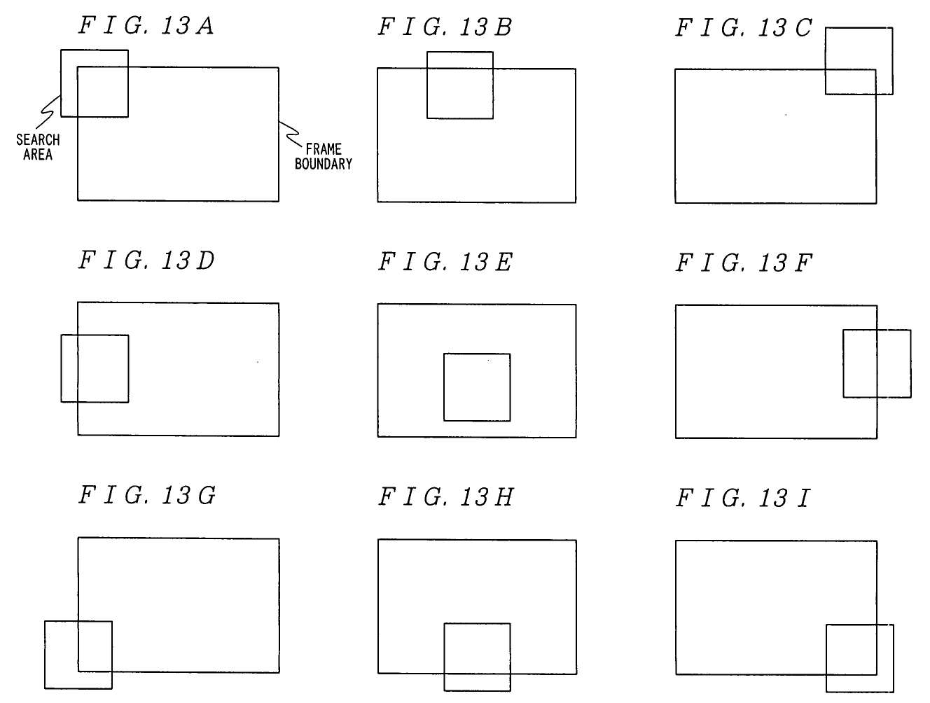

FIGS. 13A to 13I are schematic diagrams showing a form in which the search area is beyond the frame boundary.

In the case where the search area is beyond the frame boundary as shown in FIGS. 13A to 13I, the peripheral pixel generating portion 215 generates the image data (peripheral pixels) in the area beyond the frame boundary by using the macroblocks located at the frame boundary.

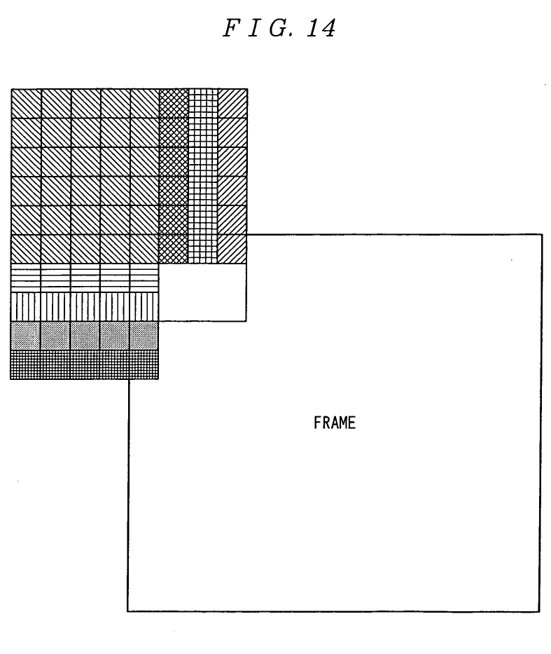

FIG. 14 is a diagram showing an example of the interpolation of the peripheral pixels performed in the case where the search area is beyond the frame boundary in the situation of FIGS. 13A to 13I. FIG. 14 shows the example of the interpolation in the case where no pixel is reduced, and the peripheral pixels of the same pattern are interpolated by the same pixels (pixels located at the frame boundary).

In FIG. 14, the macroblocks located at the frame boundary are expanded as-is outside the frame, and the macroblocks located to the upper left of the frame are expanded to an upper left area of the frame.

Thus, it is possible, by interpolating the peripheral pixels, to use the unrestricted motion vector (motion vector admitting specification beyond the frame boundary) for the encoding process. Even in the case of reading the image data to the motion detection/motion compensation processing portions 80 by the macroblock and performing the encoding process, it is possible, as with the moving image processing apparatus 1 according to the present invention, to interpolate the peripheral pixels just by using the read macroblocks so as to efficiently perform the process.

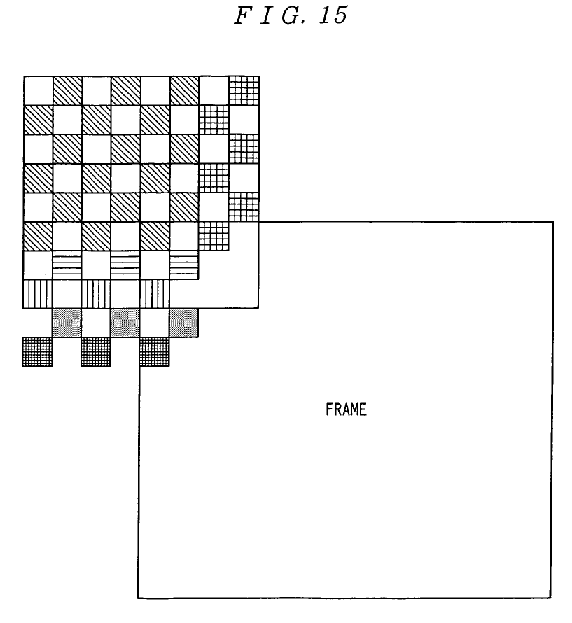

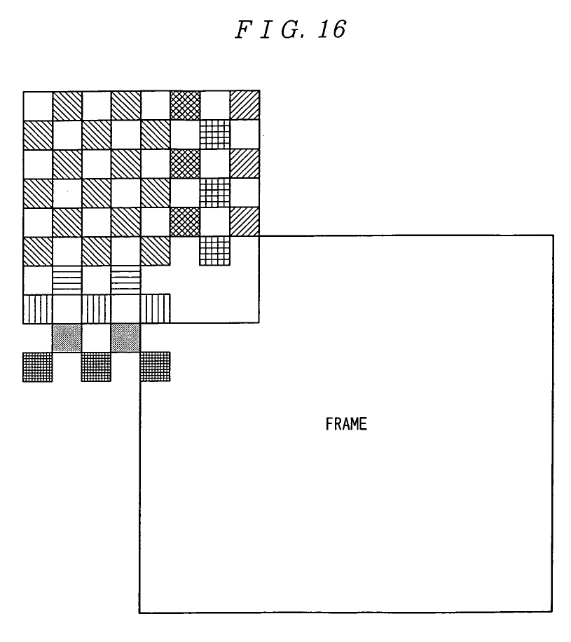

FIGS. 15 and 16 are diagrams showing the examples of the interpolation in the case where the pixels are reduced. FIG. 15 is a diagram showing an example of the interpolation of the peripheral pixels performed by using only the image data remaining after being reduced. FIG. 16 is a diagram showing an example in which a reduced and missing portion is interpolated by using the pixels before reducing in addition to pixel data remaining after reducing.

As for the forms for interpolating the pixels, it is possible to take various forms other than the examples shown in FIGS. 15 and 16.

As described above, the moving image processing apparatus 1 according to this embodiment has the reconstructed image buffer 203, search subject original image buffer 207 and encoding subject original image buffer 208 comprised of the plurality of memory banks provided to the motion detection/motion compensation processing portions 80, and has a 32-bit wide (4-pixel wide) strip-like storage area allocated to each memory bank, and further has the strip-like storage areas comprised of the memory banks arranged in order.

Therefore, it is possible to read all the pixels to be processed by one access to the memory banks in parallel in the motion detection process so as to speed up the process.

It is also possible, as the buffers are comprised of the common memory banks, to reduce the number of the memories provided to the motion detection/motion compensation processing portions 80.

The moving image processing apparatus 1 according to this embodiment performs the motion detection process having a high gravity of the load in the encoding process of the moving image in the motion detection/motion compensation processing portions 80 as the coprocessor. In this case, the motion detection/motion compensation processing portions 80 performs the motion detection process by the macroblock.

For that reason, it is possible to render the interface of the data highly consistent in the encoding process performed software-wise by the processor core 10 and the encoding process performed hardware-wise by the motion detection/motion compensation processing portions 80. And each time the motion detection of the macroblock is finished, the processor core 10 can sequentially perform the continued encoding process.

Therefore, it is possible to operate the processor core 10 and the motion detection/motion compensation processing portions 80 as the coprocessor in parallel more effectively so as to efficiently perform the encoding process of the moving image.

As the motion detection/motion compensation processing portions 80 read the image data and perform the motion detection process by the macroblock, it is possible to reduce the size of the buffers required by the motion detection/motion compensation processing portions 80 so as to perform the encoding process at low cost and with low power consumption.

Furthermore, the reconstructed image transfer portion 214 of the motion detection/motion compensation processing portions 80 transfers the reconstructed image in the local memory 40 reconstructed by the processor core 10 to the frame memory 110 by means of DMA so as to use it for the encoding.

Therefore, it is possible to reduce the processing load of the processor core 10, and so it is possible to reduce an operating frequency of the processor core 10 and thus further lower the power consumption. In the case where the moving image processing apparatus 1 is built into a mobile device such as a portable telephone, it is possible to allocate processing capability of the processor core 10 created by reducing the processing load to the processing of other applications so that even the mobile device can operate a more sophisticated application. Furthermore, the processing capability required of the processor core 10 is reduced so that an inexpensive processor can be used as the processor core 10 so as to reduce the cost.

The moving image processing apparatus 1 according to this embodiment has the function of decoding the moving image. Therefore, it is possible to decode the moving image by exploiting an advantage of the above-mentioned encoding process.

To be more specific, moving image data to be decoded is given to the moving image processing apparatus 1 so that the processor core 10 performs a variable-length decoding process so as to obtain the motion vector. The motion vector is stored in a predetermined register (motion vector register).

Then, the predictive image generating portion 212 of the motion detection/motion compensation processing portions 80 transfers the macroblock (Y, Cb and Cr components) to the local memory 40 based on the motion vector.

And the processor core 10 performs to the moving image data to be decoded the variable-length decoding process, an inverse scan process (an inverse scan zigzag scan and so on), an inverse AC/DC prediction process, an inverse quantization process and an inverse DCT process so as to store the results thereof as the reconstructed image in the local memory 40.

Then, the reconstructed image transfer portion 214 of the motion detection/motion compensation processing portions 80 DMA-transfers the reconstructed image from the local memory 40 to the frame memory 110.

Such a process is repeated for each macroblock so as to decode the moving image.

1. A moving image encoding apparatus for performing an encoding process including a motion detection process to moving image data, the apparatus including:
an encoded image buffer for storing one macroblock to be encoded of a frame constituting a moving image;
a search image buffer for storing the moving image data in a predetermined range as a search area of motion detection in a reference frame of the moving image data; and
a reconstructed image buffer for storing the moving image data in a predetermined range as a search area of a reconstructed image frame obtained by decoding the encoded reference frame, and comprises a motion detection processing section for performing the motion detection process, and
of the data constituting the frame constituting the moving image, the reference frame and the reconstructed image frame, the motion detection processing section sequentially reads predetermined data to be processed into each of the buffers so as to perform the motion detection process.

2. The moving image encoding apparatus according to claim 1, wherein at least one of the encoded image buffer, search image buffer and reconstructed image buffer has its storage area interleaved in a plurality of memory banks.

3. The moving image encoding apparatus according to claim 2, wherein the storage area is divided into a plurality of areas having a predetermined width, and the predetermined width is set based on a readout data width when the motion detection processing section reads the data and an access data width as a unit of handling in the memory banks, and each of the plurality of areas is interleaved in the plurality of memory banks.

4. The moving image encoding apparatus according to claim 3, wherein the motion detection processing section calculates a sum of absolute difference in the motion detection process in parallel at the readout data width or less.

5. The moving image encoding apparatus according to claim 3, wherein:
the storage area is divided into two areas having a 4-byte width and each of the two areas is interleaved in the two memory banks; and
the motion detection processing section processes a sum of absolute difference in the motion detection process by four pixels in parallel.

6. The moving image encoding apparatus according to claim 1, wherein the apparatus stores in the search image buffer a reduced image generated by reducing the moving image data in the predetermined range as the search area of the motion detection in the reference frame of the moving image data.

7. The moving image encoding apparatus according to claim 1, wherein the apparatus stores in the search image buffer a first reduced image generated by reducing in a size of ½ the moving image data in the predetermined range as the search area of the motion detection in the reference frame of the moving image data and a second reduced image consisting of the moving image data reduced on generating the first reduced image.

8. The moving image encoding apparatus according to claim 1, wherein each of the storage areas of the search image buffer and reconstructed image buffer is interleaved in the same plurality of memory banks.

9. The moving image encoding apparatus according to claim 1, wherein:
the search image buffer can store a predetermined number of macroblocks surrounding the macroblock located at a center of search; and
the motion detection processing section detects a motion vector for the macroblocks stored in the search image buffer, reads the macroblock newly belonging to the search area due to a shift of the center of search, out of the predetermined number of macroblocks surrounding the macroblock located at the center of search, on shifting the center of search to an adjacent macroblock, and holds the other macroblocks.

10. The moving image encoding apparatus according to claim 1, wherein:
the search image buffer stores three lines and three rows of macroblocks surrounding the macroblock located at the center of search; and
the motion detection processing section detects a motion vector for the three lines and three rows of macroblocks, reads the three lines or three rows of macroblocks newly belonging to the search area due to the shift of the center of search, out of the three lines and three rows of macroblocks surrounding the macroblock located at the center of search, on shifting the center of search to an adjacent macroblock, and holds the other macroblocks.

11. The moving image encoding apparatus according to claim 9, wherein, in the case where the range of the predetermined number of macroblocks surrounding the macroblock located at the center of search includes the outside of a boundary of the reference frame of the moving image data, the motion detection processing section interpolates the range outside the boundary of the reference frame by extending the macroblock located on the boundary of the reference frame.

12. The moving image encoding apparatus according to claim 1, wherein, in the motion detection process, the motion detection processing section detects a wide-area vector indicating rough motion for the reduced image generated by reducing the moving image data in the predetermined range as the search area of the motion detection in the reference frame of the moving image data, and detects a more accurate motion vector thereafter based on the wide-area vector for a non-reduced image corresponding to the reduced image.

13. A moving image processing apparatus including a processor for encoding moving image data and a coprocessor for assisting a process of the processor, wherein:
the coprocessor performs a motion detection process and a generation process of a predictive image and a difference image by the macroblock to the moving image data to be encoded, and outputs the difference image of the macroblock each time the process of the macroblock is finished; and
the processor continuously encodes the difference image of the macroblock each time the difference image of the macroblock is outputted from the coprocessor.

14. The moving image processing apparatus according to claim 13,
further including a frame memory capable of storing a plurality of frames of the moving image data and a local memory accessible at high speed from the frame memory,
wherein the coprocessor reads the data on the frame stored in the frame memory and performs the motion detection process and generation process of the predictive image and difference image, and outputs a generated difference image to the local memory each time the difference image is generated for each macroblock; and
the processor continuously encodes the difference image stored in the local memory.

15. The moving image processing apparatus according to claim 14, wherein:
the coprocessor outputs a generated predictive image to the local memory each time the predictive image is generated for each macroblock; and
the processor performs a motion compensation process based on the predictive image stored in the local memory and a decoded difference image obtained by encoding and then decoding the difference image, and stores a reconstructed image as a result of the motion compensation process in the local memory.

16. The moving image processing apparatus according to claim 14, wherein the coprocessor further includes a reconstructed image transfer section for DMA-transferring the reconstructed image stored in the local memory to the frame memory.

17. The moving image processing apparatus according to claim 14, wherein the coprocessor automatically generates an address referred to in the frame memory in response to the macroblocks sequentially processed on having a top address referred to in the frame memory and a frame size specified.

18. The moving image processing apparatus according to claim 14, wherein the local memory is comprised of a two-dimensional access memory.

19. The moving image processing apparatus according to claim 18, wherein, on storing the macroblock of the predictive image or difference image in the local memory, the coprocessor stores blocks included in the macroblock by placing them in a vertical line or in a horizontal line according to a size of the local memory.

20. The moving image processing apparatus according to claim 13, wherein the coprocessor includes the reconstructed image buffer for storing the data included in the reconstructed image as a result of undergoing the motion compensation process in the encoding process and reads predetermined data included in the reconstructed image to the reconstructed image buffer on performing the motion detection process for the macroblock so as to generate the predictive image about the macroblock by using the predetermined data read to the reconstructed image buffer.

21. The moving image processing apparatus according to claim 13, wherein the coprocessor includes an encoding subject image buffer for storing the data included in the moving image data to be encoded and reads predetermined data included in the moving image data to be encoded to the encoding subject image buffer on performing the motion detection process for the macroblock so as to generate the difference image about the macroblock by using the data read to the encoding subject image buffer.

22. The moving image processing apparatus according to claim 13, wherein, as to the macroblock to be encoded, the coprocessor determines which of an inter-frame encoding process or an intra-frame encoding process can efficiently encode the macroblock based on the result of the motion detection process and pixel data included in the macroblock and generates the predictive image and difference image based on the encoding process according to the result of the determination.

23. The moving image processing apparatus according to claim 22, wherein, if determined that the intra-frame encoding process can encode the macroblock to be encoded more efficiently, the coprocessor updates the predictive image to be used for the encoding process of the macroblock to zero.

24. The moving image processing apparatus according to claim 13, wherein the coprocessor detects a motion vector about each of the blocks included in the macroblock in the motion detection process and determines whether to set an individual motion vector to each block or set one motion vector to the entire macroblock according to a degree of approximation of detected motion vectors so as to generate the predictive image and difference image according to the result of the determination.

25. The moving image processing apparatus according to claim 13, wherein, in the case where the detected motion vector specifies an area beyond a frame boundary of the frame referred to in the motion detection process, the coprocessor interpolates pixel data in the area beyond the frame boundary so as to generate the predictive image and difference image.

26. The moving image processing apparatus according to claim 13, wherein, in the case where the motion vector about the macroblock is given, the coprocessor obtains the macroblock specified by the motion vector in the frame referred to, and the process or performs the motion compensation process by using the obtained macroblock so as to perform a decoding process of the moving image.

27. The moving image processing apparatus according to claim 14, wherein the processor stores in the frame memory the frame to be encoded, the reconstructed image of the frame referred to as a result of undergoing the motion compensation process in the encoding process, the frame referred to included in the moving image data to be encoded corresponding to the reconstructed image and the reconstructed image generated about the frame to be encoded so as to perform the encoding process by the macroblock, and overwrites the macroblock of the reconstructed image generated about the frame to be encoded in the storage area no longer necessary to be held from among the storage areas of the macroblock in the frame to be encoded, reconstructed image of the frame referred to, and the frame referred to.

28. A moving image processing apparatus including a processor for decoding moving image data and a coprocessor for assisting a process of the processor, wherein:
in the case where the motion vector of the moving image data to be decoded is given, the coprocessor performs a process of obtaining the macroblock specified by the motion vector from the frame referred to obtained by a decoding process to generate a predictive image by the macroblock, and outputs the predictive image of the macroblock each time the process of the macroblock is finished; and
the processor performs the motion compensation process to the predictive image of the macroblock each time the predictive image of the macroblock is outputted from the coprocessor.
